(19) United States
(12) Patent Application Publication
(10) Pub. No.: US 2005/0091432 A1
(43) Pub. Date: Apr. 28, 2005

(54) Flexible matrix fabric design framework for multiple requestors and targets in system-on-chip designs

(75) Inventors: Lyle E. Adams, San Jose, CA (US); Michael Ou, Newark, CA (US)

Correspondence Address: Matthew J. Booth & Associates, PLLC, P O BOX 50010, AUSTIN, TX, 78763-0010, US

(73) Assignee: Palmchip Corporation, San Jose, CA (US)

(21) Appl. No.: 10/695,004

(22) Filed: Oct. 28, 2003

(51) Int. Cl. G06F 13/00

(52) U.S. Cl. 710/100

(57) ABSTRACT

The System-on-Chip (SOC) interconnection apparatus and system discloses an internal switching fabric that interconnects, via standard connection ports, one or more requestors and one or more addressable targets on a single semiconductor integrated circuit. Each target has a unique address space, may or may not have internal arbitration, and may be resident (i.e., on-chip) memory, a memory controller for resident or off-chip memory, an addressable bridge to a device, system, or subsystem, or any combination thereof. Targets and requesters are connected to the internal switching fabric using target and requestor connection ports. The internal switching fabric routes signals between requesters and targets using one or more decoder/router elements that determine which target is the designated target using an internal system memory map. Dedicated arbiters may be included for targets without internal arbitration.

### CROSS REFERENCE TO RELATED APPLICATIONS

This application claims the benefits of the earlier filed U.S. Provisional Application Ser. No. 60/421,702, filed 28 Oct. 2002 (28.10.2002), which is incorporated by reference for all purposes into this specification.

### BACKGROUND OF THE INVENTION

1. Field of the Invention

The present invention relates to developing system-on-chip (SOC) designs. More specifically, the present invention provides a design framework that provides designers with the flexibility to easily add multiple requestors and targets into an SOC design, thereby increasing the bandwidth and throughput of the system, without changing the architecture of the system.

2. Description of the Related Art

Demand for memory bandwidth is constantly increasing as applications become more complex and grow more data hungry. Faster and more advanced processors are being used to run such applications, which results in the processor requiring more system memory bandwidth for data accesses and cache lines fills. In addition, peripheral interface standards are all constantly evolving to allow for more data throughput. For example, 10/100 Ethernet with transfer rates of 10 Mbits per second and 100 Mbits per second of data is being replaced with the significantly faster Gigabit Ethernet and even 10 Gigabit Ethernet. The USB 1.1 interface, which has a maximum bandwidth of 12 Mbits of data per second, is being replaced by USB 2.0, which has increased bandwidth to 480 Mbits per second now.

On a separate front, design and development time for new systems is continually shrinking as time-to-market demands force shortening of chip design schedules. This results in conflicting design constraints, where designers must balance the need to increase memory bandwidth in system designs with the constraints of shorter design and development time and less complexity of design for simpler verification. Current SOC designs that have architectures designed to increase memory bandwidth usually are highly complex and require significantly more verification time than prior, standard-bandwidth designs. In addition, these complex, high-memory-bandwidth designs lack flexibility when changes need to be made to the system architecture.

Accordingly, a design framework and approach are required that enable SOC designers to efficiently develop complex, increased-bandwidth SOC designs that are flexibly upgradeable, capable of efficient verification, and marketable after a reasonably short development time. Ideally, such a framework would support a wide range of designs and design complexity, from single target/single requestor to multiple target/multiple requestor designs. It would support both original design efforts and upgrades. It would enable designers to increase memory bandwidth of SOCs in development by adding additional memory targets and allow additional requestors to be added without affecting the design of the individual targets and/or requestors. It would support multi-port devices that may be both targets and requestors. It would support different bus protocols between and among the targets and requestors. It would enable flexible system upgrades and modification. And finally, it would provide support for arbitrary pipelining, rendering it usable for both small and large chip designs.

The matrix fabric framework of the present invention is such a design framework and approach.

### SUMMARY OF THE INVENTION

The present invention is a System-on-Chip (SOC) interconnection apparatus and system, wherein one or more requestors and one or more addressable targets are interconnected by an internal switching fabric on a single semiconductor integrated circuit. Each target has a unique address space and may be resident (i.e., on-chip) memory, a memory controller for resident or off-chip memory, an addressable bridge to a device, an addressable bridge to a system or subsystem, or any combination thereof. Independently accessible ports on multi-port devices may also be individual targets, and some devices, such as a PCI bridge, may function both as a requestor and a target. The present invention supports targets with internal arbitration, and those without. Targets and requesters are connected to the internal switching fabric of the present invention using target connection ports and requestor connection ports.

The internal switching fabric of the present invention routes signals between requestors and targets using one or more decoder/router elements. Each decoder/router element receives a request from a requestor, determines which target is the designated target using an internal system memory map, and routes the request to the designated target. The internal system memory map used in an individual decoder/router element may include unique address space information for all of the targets in a system, or less than all of the targets in a system. A single decoder/router element may route requests to all of the targets in a system, or fewer than all of the targets in a system.

The internal switching fabric may also include independent arbiters dedicated to targets that do not have internal arbitration. Finally, the signals routed between the decoder/routers and the targets by the interconnection fabric are registered, point-to-point signals, enabling practitioners of the present invention to add an arbitrary number of pipeline stages for timing or other purposes during design, layout, or modification of the SOC.

### DESCRIPTION OF THE DRAWINGS

To further aid in understanding the invention, the attached drawings help illustrate specific features of the invention and the following is a brief description of the attached drawings:

FIG. 1 shows a standard computer workstation 10 of the type commonly used and suitable for SOC and other chip design activities.

FIG. 2 shows a conceptual diagram of the present invention 100.

FIG. 3 shows an example of a requester connection port structure.

FIG. 4 shows the structure of two types of target connection ports and the internal switching fabric included in the present invention.

FIG. 5. is a block diagram of a typical decoder/router element 302.

FIG. 6. shows an example four-requestor/three-target system that uses the present invention.

FIG. 7 shows a second example system that uses the present invention, having five requesters and five targets.

### DETAILED DESCRIPTION OF THE INVENTION

The present invention is a design framework and approach that enables SOC designers to develop flexibly upgradeable, complex, high-memory-bandwidth SOC designs that are capable of efficient verification and ready for the market in a reasonable amount of time. This disclosure describes numerous specific details that include specific structures, circuits, and logic functions in order to provide a thorough understanding of the present invention. One skilled in the art will appreciate that one may practice the present invention without these specific details.

The Matrix Fabric framework of the present invention is used in system-on-chip designs containing one or more requestors for a shared system resource, which is typically, but not limited to, a memory device. In this description, a “requestor” is a functional module that makes a request to either read data or information from a target in the system or write data or information to a target in the system. To illustrate, one common requester is a central processing unit (CPU) that requests data and information from one or more targets for instruction code fetches, cache line fills, and data processing. Other requesters include direct memory access (DMA) controllers that transfer blocks of data to and from system memory, and external I/O interface peripherals that transfer blocks of data from the I/O interface to and from system memory. Examples of external I/O interface peripherals include Universal Serial Bus (USB) host and device interfaces, Ethernet 10/100 or Gigabit interfaces, Peripheral Component Interconnect (PCI) interfaces, and Integrated Disk Electronics (IDE).

A “target” is a functional module that provides one or more data ports or addressable locations that can be read or written by an external requester. Typical targets in system-on-chips include embedded SRAM, external Flash, and external dynamic RAM (synchronous or double-date rate). A target can also be a single access device that controls several possible targets. This might include a centralized memory controller that controls an external Flash and external SDRAM and which can process a single request to one of its targets.

Not all “targets” are memory devices. Peripheral devices and bus bridges can also be targets in the context of this disclosure. Examples of these kinds of targets might include a PCI controller acting as a bridge to a PCI memory device, an IDE Host Controller serving as a bridge to an IDE Target device, or a digital-to-analog converter generating an analog signal.

In a typical system-on-chip configuration, different requesters all need access to system resources, which is often system memory. Many system-on-chip designs use a single memory target for a variety of reasons, including simplicity of design and cost. In these designs, all memory requestors must arbitrate for the target memory. The target system memory throughput is generally determined by the maximum throughput of the target memory and the clock frequency of the target. For example, if the target memory is a 32-bit wide internal SRAM that is accessible every clock cycle, the maximum possible throughput for this system is 4 bytes per clock cycle. A system running at 100 MHz then would have a memory throughput of 400 Mbytes per second. In single target systems, memory bandwidth can only be increased by expanding the throughput of the target memory (e.g. using a 64-bit memory, or by increasing the clock frequency). In this same single target system, using a 64-bit internal SRAM running at 100 MHz would increase the total throughput to 8 bytes per clock cycle, or 800 Mbytes per second at 100 MHz. Running this system at twice the clock speed would double this to 1.6 Gbytes per second.

Ordinarily, requesters in a single target system will not require access to the same region of memory at the same time. In the example of a single target memory controller which supports separate Flash and SDRAM address spaces, one requestor may want to read from the Flash while the other requestor may want to write the SDRAM. Since there is a only a single target, both requestors must arbitrate for memory and one of them will have to wait until the other requester completes its transfer.

Similarly, in some systems, certain address spaces are only accessible by specific requestors. For example, in a multi-CPU system, processor instruction fetches and cache line fills only occur from one address range in Flash space, while networking packets from Ethernet interfaces are stored in a different SDRAM address range. In these systems, even though there is no danger of two requestors trying to access the same area of memory, both requesters must still arbitrate for access to the single memory target.

In both of these types of systems, if the architecture were redesigned such that the different address spaces were separate targets, simultaneous and parallel access could be allowed, thus increasing system throughput. In this approach, the second target would exist in a different address range in system memory and could be accessible by one or more of the memory requestors. Memory bandwidth is increased when the different memory requestors do not all access the same memory target at the same, with the peak memory throughput being the sum of the maximum bandwidths of each of the individual targets. A multi-memory target system with an internal 32-bit SRAM accessible every cycle and an external 64-bit SDRAM accessible every cycle will have a peak bandwidth of 12 bytes per cycle (4 bytes per cycle from the 32-bit SRAM and 8 bytes per cycle from the 64-bit SDRAM), or 1.2 Gbytes per second when running at 100 MHz. Adding a third or even more memory targets is also possible, and would increase overall system bandwidth accordingly when all targets are concurrently accessible.

The tradeoff designers face when adding extra targets is the increased system design complexity. In most systems, adding another target means that each requestor must now be modified to add in a new set of control and data signals to communicate with the new target, and the SOC layout must be modified to add data paths between the requestors and the new target. To illustrate, consider an example system with a CPU and seven DMA memory requestors all accessing a single memory target. If a second memory target is added, then all of the memory requesters must be modified to add in the appropriate control and data path logic to communicate with this new target. If, later in the design cycle, the architecture is enhanced to add a third memory target, all of the requestors and the system design must be modified again. If the decision is made on a multi-target system to revert back to a single target system with higher throughput (e.g. switching from two 32-bit memory targets to a single 64-bit memory target), then all of the designs must be changed again. Making these kinds of changes during the design cycle always results in increased design and verification time, and usually increases the overall complexity of the chip.

The Matrix Fabric design framework was invented in order to solve these problems. The framework supports a wide range of configurations, from a single requestor and a single target to multiple requestors and multiple targets, rendering the Matrix Fabric suitable for a variety of applications, from lower bandwidth and lower cost designs to higher performance and higher bandwidth systems.

The Matrix Fabric provides flexibility for adding requesters and targets to a system-on-chip design, either during the initial design process or during subsequent upgrades. In designs using the present invention, requesters do not need to know what targets are available. Adding targets has no impact on the requestor design, and only minimal changes are required to the Matrix Fabric itself. Adding requestors requires adding an extra standard interface connection port to the Matrix Fabric; as each requestor requires only a single interface connection port to the Matrix Fabric, as described in greater detail below.

The Matrix Fabric decodes all requests and routes them to the appropriate target. Arbitration for the targets can be determined either by the target itself or by an arbiter built into the Matrix.

The Matrix Fabric takes a “building block” approach to interconnecting requestors and targets, where the building blocks include standard requester and target connection ports, a decoder/router element per requestor, and an optional arbitration unit for each target. Abstraction of the entire fabric into a single module allows for easier modification and maintenance. When requesters and targets are to be added or removed, only one functional module has to be updated rather than making changes across different modules throughout the entire chip.

The architecture of the Matrix Fabric allows for requesters and targets to be easily added. Adding a requestor involves adding the requestor connection port and a decoder/router element. Adding a target involves adding the target connection port and updating the decoder/router element(s). Because the design is simple, these changes can easily be made by hand. In addition, the regularity of the building block structures of the Matrix Fabric make this interconnection architecture well suited for automatic generation of register transfer level (RTL) code using computer scripts or other software.

The Matrix Fabric supports arbitrary pipelining, meaning that during the design or physical layout of the system-on-chip, designers are free to add pipeline stages between requesters and targets for timing or other purposes, without adversely affecting the synchronization of the logic. All signals routed from the decoder/router element(s) in the Matrix Fabric to either the optional arbiters or to the memory target ports are point-to-point and registered, meaning that the signals are not directly connected to functional logic at either their start or termination point, but instead, are launched and captured by flip-flops. Thus, pipeline stages can be hidden inside the Matrix Fabric structure. The bus protocols of the input and output ports are preferably fully registered, so that pipeline stages can also be added to the input and output ports of the Matrix Fabric. Arbitrary pipelining support helps solve the problem of timing issues when the physical design of the chip grows larger, resulting in longer wiring delays, or when the clock frequency increases. As a result, the fabric can be used in both small and large designs, and in high-frequency and low-frequency designs.

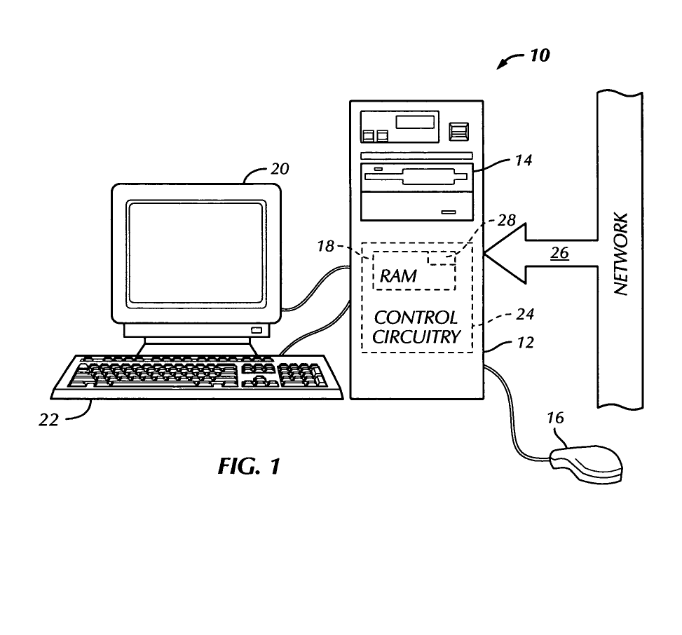

FIG. 1 shows a standard computer workstation 10 of the type commonly used and suitable for SOC and other chip design activities. The computer workstation 10 shown in FIG. 1 is suitable for practicing the design and modification aspects of the present invention discussed herein, and may also incorporate SOCs utilizing the present invention. Those skilled in the art will understand that SOCs that incorporate the present invention may also be used in any of a number of platforms, including but not limited to handheld devices such as personal data assistants, communications devices, servers, mainframes, embedded systems, laptops, and consumer electronics.

As shown in FIG. 1, the workstation 10 comprises a monitor 20 and keyboard 22, a processing unit 12, and various peripheral interface devices that might include removable media local storage 14 and a mouse 16. Processing unit 12 further includes internal memory 18, and internal storage (not shown in FIG. 1) such as a hard drive.

Workstation 10 interfaces with digital control circuitry 24 and executable software 28 that may include, for example, device design and layout software if the computer workstation 10 is functioning as a device design and layout workstation. In the preferred embodiment shown in FIG. 1, digital control circuitry 24 is a general-purpose computer including a central processing unit, RAM, and auxiliary memory. Both the executable software 28 and the digital control circuitry 24 are shown in FIG. 1 as residing within processing unit 12 of workstation 10, but both components could be located in whole or in part elsewhere, and interface with workstation 10 over connection 26 or via removable media local storage 14. As shown in FIG. 1, connection 26 could be a connection to a network of computers or other workstations, which could also be connected to printers, external storage, additional computing resources, and other network peripherals. One skilled in the art will recognize that the software design and layout aspects of the present invention can be practiced upon any of the well known specific physical configurations of standalone or networked design workstations.

The operator interfaces with digital control circuitry 24 and the software 28 via the keyboard 22 and/or the mouse 16. Control circuitry 24 is capable of providing output information to the monitor 20, the network interface 26, and a printer (not shown in FIG. 1).

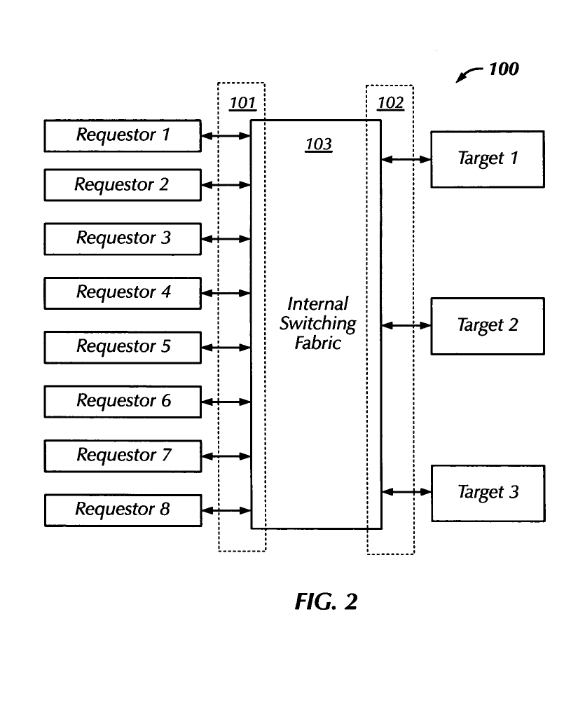

FIG. 2 shows a conceptual diagram of the present invention 100. Conceptually, the Matrix Fabric 100 can be broken into three sections: the connection ports to the requestors 101, the connection ports to the targets 102, and the internal switching fabric 103.

As discussed in further detail below, each connection port includes standard requestor control and data signals that would otherwise go to a generic target. These signals should be part of a system-on-chip bus protocol and typically include, but are not limited to, address, read/write direction, read/write data, and the appropriate control signals. Any requesters can be connected to any connection port in the Matrix Fabric, and there is no limit to the number of requesters that the present invention can accommodate.

Since each requestor is connected to the Matrix Fabric through a port, the implementation of the connections results in a regular structure. The addition of another requestor can be performed by copying an existing port module having the same interface. As described above, the repetitive arrangement of the structure is highly adaptable to the automatic generation of RTL code using computer scripts or other software executing on a design workstation such as that shown in FIG. 1.

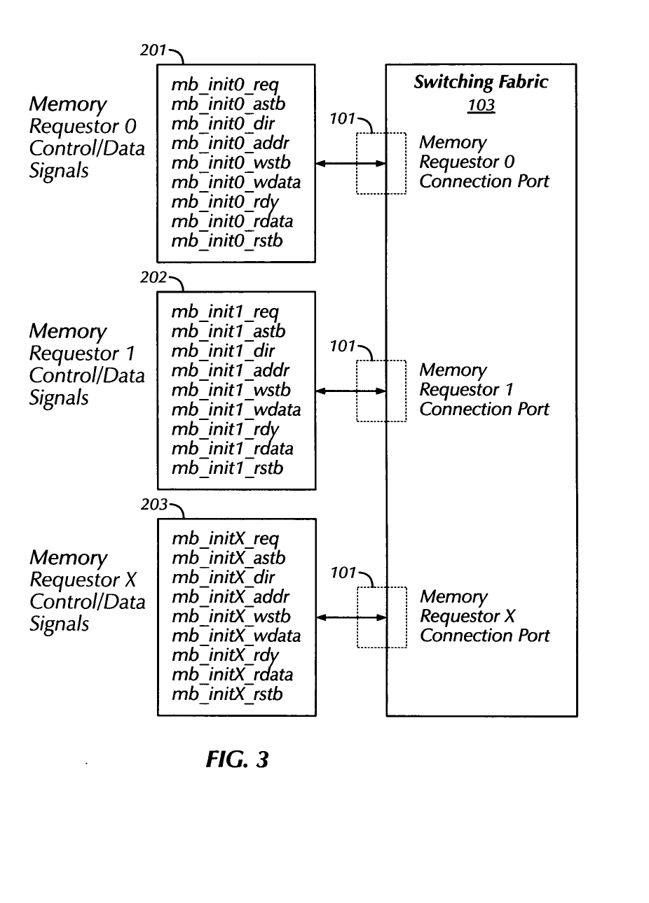

FIG. 3 shows an example of a requestor connection port structure. FIG. 3 includes three requestors: requestor 0 201, requestor 1 202, and requestor X 203. As shown in FIG. 3, in this example, each requestor connection port includes a standard set of signals including a bus request signal (e.g., mb_init0_req); various data and control strobes (e.g., mb_init0_astb, mb_init0_wstb, and mb_init0_rstb); a flow control signal (e.g., mb_init0_rdy); a read/write control signal (e.g., mb_init0_dir); a target address signal (e.g., mb_init0_addr); and data signals (e.g., mb_init0_rdata and mb_init0_wdata). Adding a connection port for another requestor with the same interface signaling requires only copying the requestor X signals and changing the X to something else, e.g. requestor ‘2’. Those skilled in the art will understand that the number, name, and types of specific signals included in each connection port may vary as a matter of design choice, and the signal types, names, and number of signals shown in FIG. 3 are not intended to convey any limitation of the present invention to the signals shown.

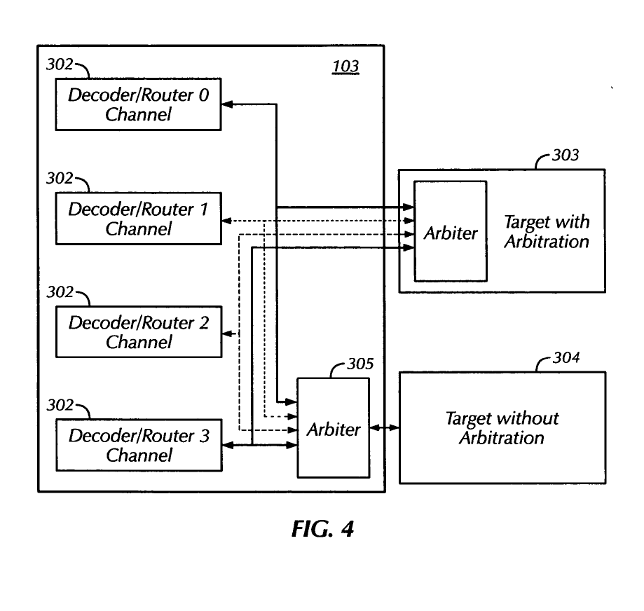

FIG. 4 shows the structure of the two types of target connection ports included in the present invention. As shown in FIG. 4, a target with built-in arbitration 303 receives a signal from each decoder/router channel 302 within the switching fabric 103. These signals are routed to the target's arbitration port. Targets with no arbitration receive a single set of signals from an arbiter 305 built into the switching fabric 103. The switching fabric portion of the present invention, including the decoder/router channel 302 and the built-in arbiter 305, is described in further detail below.

FIG. 4 also displays the structure of the internal switching fabric 103. The internal switching fabric 103 includes one or more special decoder/router elements 302. Each decoder/router unit 302 is connected to a single requestor through a requestor connection port. The decoder/router unit 302 receives a request from its associated requestor and routes this to the designated target using an internal system memory map that contains the address ranges to which each target connected to the internal switching fabric 103 via a target connection port is mapped. In a preferred embodiment, the internal system memory map comprises a central memory map file included in the decoder design. Each target is mapped to a pre-defined address range; the decoder reads the address of the request and uses the internal system memory map to route the request to the designated target(s).

After reading this specification and/or practicing the present invention, those skilled in the art will understand that the decoder/router unit design in the Matrix Fabric enables the present invention to support different system-on-chip bus protocols. The requestors can implement one system-on-chip bus protocol, while the targets can support a different protocol. In addition, each requestor and each target may use the same system-on-chip bus protocol or each may use any number of different system-on-chip bus protocols. This feature allows more flexibility when integrating different design components. As described in further detail below, the decoder/router elements translate requests framed in the requestor bus protocol and route the requests to the appropriate target(s) in the target system bus protocol.

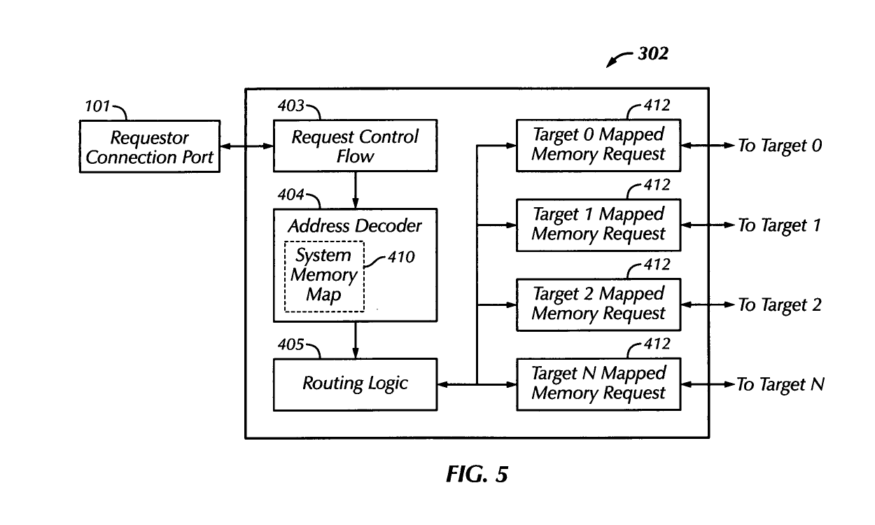

A block diagram of a typical decoder/router element 302 is detailed in FIG. 5. The decoder/router 302 interfaces directly to the requester connection port 101. Requests are received by the request control flow block 403, which stores requests and controls when requests are issued to the targets and when data transactions complete. The address decoder block 404 decodes the incoming address of each request and determines its intended target by using an internal system memory map 410 that identifies which address spaces belong to each target. Once the target is determined, the router logic 405 routes requests 412 to their designated target(s).

The internal switching fabric provides flexibility regarding communication between specific requestors and specific targets. Oftentimes, some requesters in a multiple-requestor/multiple-target system do not need access to all of the targets. For example, consider a four-requestor/two-target system comprising two CPUs and two peripheral I/Os (the four requesters) and a flash controller and an SDRAM controller (the two targets). In this example system, all four requestors require access to the SDRAM but only the two CPUs require access to the flash. In this case, the internal switching fabric can be set up so that all four requestors connect to the SDRAM but only the two CPU's connect to the flash controller. This optimization saves logic, area and routing congestion.

To implement the above approach, individual decoder/router elements 302 are designed for each combination of targets that a requestor requires. For example, if a requestor requires access to only a single target, a single target decoder/router element is created which has only one request output port. If a memory requestor requires connections to three different targets, then the decoder/router element uses three different request output ports.

In many systems, all of the requestors are allowed access to all of the targets, and thus the same design of a decoder/router element 302 can be used for all requestor ports. This allows for simplicity in adding new requestors and targets. When a new requestor is added, the internal switching fabric 103 requires only an additional decoder/router element 302. If a new target is added, the existing decoder/router element(s) need(s) a new memory target port. These design changes to the source design descriptions can easily be performed by hand, or automatically through use of computer scripts or other software executing on a workstation such as that shown in FIG. 1.

Systems may have two or more different types of decoder/router elements in the internal switching fabric. For example, systems wherein some requesters do not require access to all targets may have a two-target decoder and a three-target decoder to handle the different requestor/target paths. However, typically only a few different types of decoder/routers are ever required in most system implementations. Because of the regular structure of the Matrix Fabric, at most only a few decoder/router elements need to be designed; combinations of the decoder/router elements can create all of the desired designs. Alternatively, computer scripts or other software executing on a workstation can be used to automatically generate any required combination of decoder/router element designs.

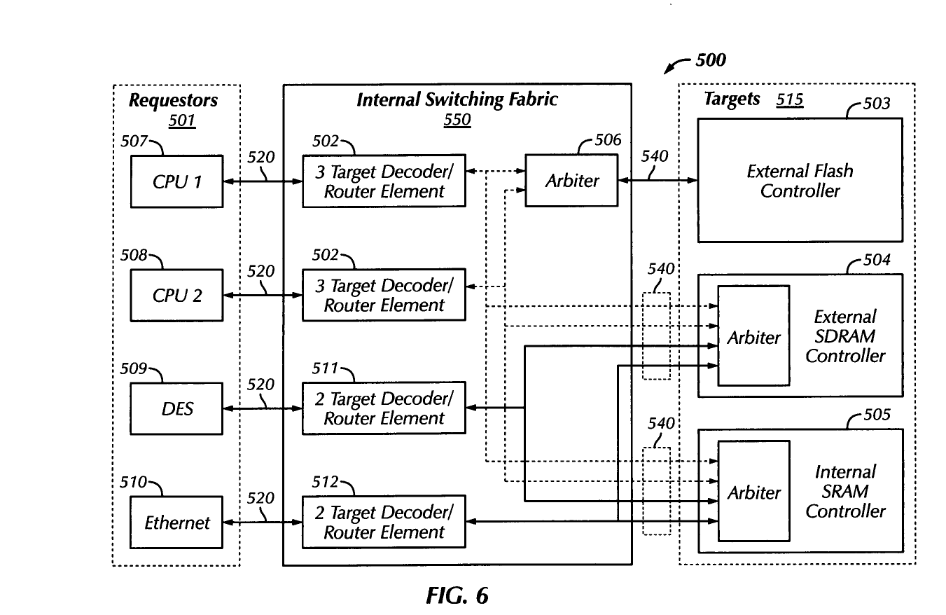

An example system 500 that uses the Matrix Fabric of the present invention is shown in FIG. 6. In this system 500 there are four requestors 501 (CPU1 507, CPU2 508, and two DMA peripherals 509 and 510) and three targets 515 (a controller for external flash 503 used for code execution, a controller for external SDRAM 504 used for main system memory, and a controller for high speed internal SRAM 505). Each requestor is connected to a decoder/router element (502, 511, and 512) in the internal switching fabric 550 via a requestor connection port 520. Each target is connected to the internal switching fabric 550 via a target connection port 540. The decoder/router elements receive the input request and map these to the appropriate target based on the address of the request.

Example system 500 illustrates several of the features of the present invention. The first target, the external flash controller 503, is a slave that has no internal arbitration, so an arbitration unit 506 for this target is built into the switching fabric 550. In addition, since the only requesters that require access to the external flash 503 are the two CPUs 507 and 508, these are the only requestors connected to this target via router/decoder elements.

The second and third targets are an SDRAM memory controller 504 and an on-chip SRAM controller 505, respectively. Both of these targets are accessible by all of the requestors, and both targets also have internal arbitration. Accordingly, since the two CPUs require access to all three targets, but the two DMA peripherals require access to only two of the targets, the CPUs each use a “three-target” decoder/router element 502, while the two DMA requestors each use a “two-target” decoder/router element 511, 512.

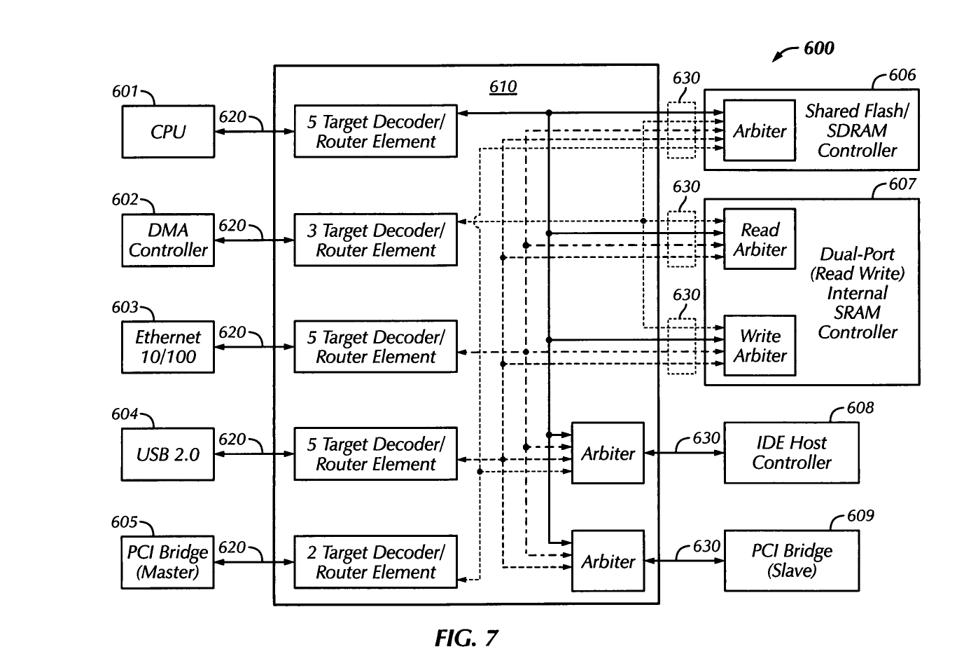

FIG. 7 shows a second example system 600 that uses the Matrix Fabric of the present invention. System 600 has five requestors and five targets. The five requestors include a CPU 601, a DMA controller 602, an Ethernet 10/100 peripheral 603, a USB 2.0 Host peripheral 604, and the master interface 605 of a PCI bridge. The targets include a single port memory controller 606 that controls a separate external flash and separate SDRAM controller, a dual port internal SRAM 607 having separate read and write ports, a IDE Host Controller 608, and the slave interface 609 of the PCI Bridge listed above. All requestors connect to the switching fabric 610 via requestor connection ports 620. All targets connect to the switching fabric 610 via target connection ports 630.

The FIG. 7 example system illustrates some aspects of the present invention not covered in the FIG. 6 system. In system 600, the same PCI Bridge functions both as a requestor 605 and a target 609. The PCI Bridge contains a master interface 605 that generates requests to other targets in the system 600. The PCI bridge also has a separate target interface 609 that allows the bridge to receive and process requests from the other requestors in the system. In this example, the PCI Bridge master 605 can generate requests that are routed through the internal switching fabric 610 destined for the IDE Host Controller 608 and the shared flash/SDRAM controller 606. The PCI Bridge slave 609 can receive requests that have been routed through the internal switching fabric 610 from the CPU 601, the Ethernet peripheral 603, and the USB host 604. The structure of the Matrix Fabric allows a single device—in this case a PCI bridge—having two separate ports to act as both a requestor and a target.

Similarly, the Dual-Port internal SRAM controller 606 is a single device that acts as two separate targets, since each port can be independently accessed. As shown in FIG. 7, each port has its own built-in arbiter. Therefore, in system 600, reads from the SRAM can occur simultaneous with writes to the SRAM.

The IDE Host Controller target 608 and the PCI Controller target 609 both act as bridges to other devices/systems. Both of these device bridges are designed as targets, having a target interface, so that they are addressable by a requestor. This design approach allows transfers to occur from the Ethernet device 603 or USB 2.0 device 604 through the switching fabric 610 directly to the IDE Host Controller 608 or the PCI Controller 609.

In summary, the present invention is a System-on-Chip (SOC) interconnection apparatus and system, wherein an internal switching fabric interconnects one or more requestors and one or more targets on a single semiconductor integrated circuit. Each target has a unique address space, may or may not have its own arbitration, and may be resident (i.e., on-chip) memory, a memory controller for resident or off-chip memory, an addressable bridge to a device, system, or subsystem, or any combination thereof. Targets and requestors are connected to the internal switching fabric of the present invention using target connection ports and requestor connection ports.

Signals are routed between requesters and targets using one or more decoder/router elements within the internal switching fabric. Each decoder/router element receives a request from a requestor, determines which target is the designated target using an internal system memory map, and routes the request to the designated target. The internal system memory map used in an individual decoder/router element may include unique address space information for all of the targets in a system, or fewer than all of the targets in a system. A single decoder/router element may route requests to all of the targets in a system, or fewer than all of the targets in a system.

The internal switching fabric may also include independent memory arbiters dedicated to memory targets that do not have internal arbitration. Finally, the signals routed between the decoder/routers and the memory targets by the interconnection fabric are registered, point-to-point signals, enabling practitioners of the present invention to add an arbitrary number of pipeline stages for timing or other purposes during design, layout, or modification of the SOC.

Other embodiments of the invention will be apparent to those skilled in the art after considering this specification or practicing the disclosed invention. The specification and examples above are exemplary only, with the true scope of the invention being indicated by the following claims.

1. A System-on-Chip (SOC) interconnection apparatus, comprising:
a single semiconductor integrated circuit that includes one or more requestors and one or more addressable targets, wherein each said addressable target has a unique address space and further comprises one or more of the following: resident memory, a memory controller for resident or off-chip memory, an addressable bridge to a device, an addressable bridge to a system, or an addressable bridge to a sub-system;
an internal switching fabric that routes signals between said requesters and said addressable targets, said internal switching fabric further comprises one or more decoder/router elements, wherein each decoder/router element receives a request from a requestor, determines which said addressable target is the designated target using an internal system memory map, and routes said request to said designated target;
one or more requestor connection ports, wherein each said connection port connects one of said requesters to said internal switching fabric; and
one or more target connection ports, wherein each said target port connects one of said addressable targets to said internal switching fabric.

2. A system that includes a System-on-Chip (SOC) having an interconnection apparatus comprising:
a single semiconductor integrated circuit that includes one or more requesters and one or more addressable targets, wherein each said addressable target has a unique address space and further comprises one or more of the following: resident memory, a memory controller for resident or off-chip memory, an addressable bridge to a device, an addressable bridge to a system, or an addressable bridge to a sub-system;
an internal switching fabric that routes signals between said requestors and said addressable targets, said internal switching fabric further comprises one or more decoder/router elements, wherein each decoder/router element receives a request from a requestor, determines which said addressable target is the designated target using an internal system memory map, and routes said request to said designated target;
one or more requestor connection ports, wherein each said connection port connects one of said requesters to said internal switching fabric; and
one or more target connection ports, wherein each said target port connects one of said addressable targets to said internal switching fabric.

3. A method to make a System-on-Chip (SOC) interconnection apparatus, comprising:
providing a single semiconductor integrated circuit that includes one or more requestors and one or more addressable targets, wherein each said addressable target has a unique address space and further comprises one or more of the following:
resident memory, a memory controller for resident or off-chip memory, an addressable bridge to a device, an addressable bridge to a system, or an addressable bridge to a subsystem;
coupling an internal switching fabric to said addressable targets and said requesters, said internal switching fabric routes signals between said requesters and said addressable targets, said internal switching fabric further comprises one or more decoder/router elements, wherein each decoder/router element receives a request from a requester, determines which said addressable target is the designated target using an internal system memory map, and routes said request to said designated target;
providing one or more requestor connection ports, wherein each said connection port connects one of said requestors to said internal switching fabric; and
providing one or more target connection ports, wherein each said target port connects one of said addressable targets to said internal switching fabric.

4. A method to use a System-on-Chip (SOC) interconnection apparatus, comprising:
receiving a request from one of one or more requestors over a requestor connection port coupled to said one requestor and to an internal switching fabric;
determining which one of one or more addressable targets is the designated target using an internal system memory map; and
routing said request to said designated target over a target connection port coupled to said internal switching fabric;
wherein said internal switching fabric, said one or more requesters, and said one or more addressable targets are all included on a single semiconductor integrated circuit, wherein each said addressable target has a unique address space and further comprises one or more of the following: resident memory, a memory controller for resident or off-chip memory, an addressable bridge to a device, an addressable bridge to a system, or an addressable bridge to a subsystem, and wherein said internal switching fabric routes signals between said requesters and said addressable targets and further comprises one or more decoder/router elements that receive said request from a requestor.

5. A program storage device readable by a computer that tangibly embodies a program of instructions executable by the computer to perform a method to use a System-on-Chip (SOC) interconnection apparatus, said method comprising:
receiving a request from one of one or more requesters over a requester connection port coupled to said one requestor and to an internal switching fabric;
determining which one of one or more addressable targets is the designated target using an internal system memory map; and
routing said request to said designated target over a target connection port coupled to said internal switching fabric;
wherein said internal switching fabric, said one or more requesters, and said one or more addressable targets are all included on a single semiconductor integrated circuit, wherein each said addressable target has a unique address space and further comprises one or more of the following: resident memory, a memory controller for resident or off-chip memory, an addressable bridge to a device, an addressable bridge to a system, or an addressable bridge to a subsystem, and wherein said internal switching fabric routes signals between said requesters and said addressable targets and further comprises one or more decoder/router elements that receive said request from a requestor.

6. A dependent claim according to claim 1, 2, 3, 4, or 5, wherein said internal switching fabric further comprises one or more arbiters.

7. A dependent claim according to claim 1, 2, 3, 4, or 5, wherein one of said one or more decoder/router elements further comprises one of the following:
a decoder/router element that routes requests to all of said one or more addressable targets using an internal system memory map that includes unique address space information for all of said one or more addressable targets;
a decoder/router element that routes requests to less than all of said one or more addressable targets using an internal system memory map that includes unique address space information for all of said one or more addressable targets; or
a decoder/router element that routes requests to less than all of said one or more addressable targets using an internal system memory map that includes unique address space information for less than all of said one or more addressable targets.

8. A dependent claim according to claim 1, 2, 3, 4, or 5, wherein one of said one or more requestors and one of said one or more addressable targets together further comprise a single device having an independently accessible requestor port and an independently accessible target port.

9. A dependent claim according to claim 1, 2, 3, 4, or 5, wherein one of said one or more addressable targets further comprises a single device having two independently accessible target ports.

10. A dependent claim according to claim 1, 2, 3, 4, or 5, wherein said request routed to said designated target by said decoder/router element further comprises a registered, point-to-point signal that further comprises a plurality of pipeline stages.

11. A System-on-Chip (SOC) interconnection apparatus, comprising:
a single semiconductor integrated circuit that includes one or more requesters and one or more addressable targets, wherein each said addressable target has a unique address space and further comprises one or more of the following: resident memory, a memory controller for resident or off-chip memory, an addressable bridge to a device, an addressable bridge to a system, or an addressable bridge to a subsystem;
an internal switching fabric that routes signals between said requestors and said addressable targets, said internal switching fabric further comprises one or more decoder/router elements and one or more arbiters, wherein each decoder/router element receives a request from a requester, determines which said addressable target is the designated target using an internal system memory map, and routes said request to said designated target, wherein said request routed to said designated target further comprises a registered, point-to-point signal having a plurality of pipeline stages;
one or more requestor connection ports, wherein each said connection port connects one of said requestors to said internal switching fabric; and
one or more target connection ports, wherein each said target port connects one of said addressable targets to said internal switching fabric;
wherein one of said one or more decoder/router elements further comprises one of the following:
a decoder/router element that routes requests to all of said one or more addressable targets using an internal system memory map that includes unique address space information for all of said one or more addressable targets;
a decoder/router element that routes requests to less than all of said one or more addressable targets using an internal system memory map that includes unique address space information for all of said one or more addressable targets; or
a decoder/router element that routes requests to less than all of said one or more addressable targets using an internal system memory map that includes unique address space information for less than all of said one or more addressable targets; and
wherein one of said one or more requestors and one of said one or more addressable targets together further comprise a single device having an independently accessible requester port and an independently accessible target port; or
one of said one or more addressable targets further comprises a single device having two independently accessible target ports.

12. A system that includes a System-on-Chip (SOC) having an interconnection apparatus comprising:
a single semiconductor integrated circuit that includes one or more requestors and one or more addressable targets, wherein each said addressable target has a unique address space and further comprises one or more of the following: resident memory, a memory controller for resident or off-chip memory, an addressable bridge to a device, an addressable bridge to a system, or an addressable bridge to a subsystem;
an internal switching fabric that routes signals between said requestors and said addressable targets, said internal switching fabric further comprises one or more decoder/router elements and one or more arbiters, wherein each decoder/router element receives a request from a requester, determines which said addressable target is the designated target using an internal system memory map, and routes said request to said designated target, wherein said request routed to said designated target further comprises a registered, point-to-point signal having a plurality of pipeline stages;
one or more requestor connection ports, wherein each said connection port connects one of said requesters to said internal switching fabric; and
one or more target connection ports, wherein each said target port connects one of said addressable targets to said internal switching fabric;
wherein one of said one or more decoder/router elements further comprises one of the following:
a decoder/router element that routes requests to all of said one or more addressable targets using an internal system memory map that includes unique address space information for all of said one or more addressable targets;
a decoder/router element that routes requests to less than all of said one or more addressable targets using an internal system memory map that includes unique address space information for all of said one or more addressable targets; or
a decoder/router element that routes requests to less than all of said one or more addressable targets using an internal system memory map that includes unique address space information for less than all of said one or more addressable targets; and
wherein one of said one or more requestors and one of said one or more addressable targets together further comprise a single device having an independently accessible requestor port and an independently accessible target port; or
one of said one or more addressable targets further comprises a single device having two independently accessible target ports.

13. A method to make a System-on-Chip (SOC) interconnection apparatus, comprising:
providing a single semiconductor integrated circuit that includes one or more requesters and one or more addressable targets, wherein each said addressable target has a unique address space and further comprises one or more of the following: resident memory, a memory controller for resident or off-chip memory, an addressable bridge to a device, an addressable bridge to a system, or an addressable bridge to a subsystem;
providing an internal switching fabric that routes signals between said requestors and said addressable targets, said internal switching fabric further comprises one or more decoder/router elements and one or more arbiters, wherein each decoder/router element receives a request from a requester, determines which said addressable target is the designated target using an internal system memory map, and routes said request to said designated target, wherein said request routed to said designated target further comprises a registered, point-to-point signal having a plurality of pipeline stages;
providing one or more requestor connection ports, wherein each said connection port connects one of said requestors to said internal switching fabric; and
providing one or more target connection ports, wherein each said target port connects one of said addressable targets to said internal switching fabric;
wherein one of said one or more decoder/router elements further comprises one of the following:
a decoder/router element that routes requests to all of said one or more addressable targets using an internal system memory map that includes unique address space information for all of said one or more addressable targets;
a decoder/router element that routes requests to less than all of said one or more addressable targets using an internal system memory map that includes unique address space information for all of said one or more addressable targets; or
a decoder/router element that routes requests to less than all of said one or more addressable targets using an internal system memory map that includes unique address space information for less than all of said one or more addressable targets; and
wherein one of said one or more requestors and one of said one or more addressable targets together further comprise a single device having an independently accessible requestor port and an independently accessible target port; or
one of said one or more addressable targets further comprises a single device having two independently accessible target ports.

14. A method to use a System-on-Chip (SOC) interconnection apparatus, comprising:
receiving a request from one of one or more requestors over a requestor connection port coupled to said one requestor and to an internal switching fabric;
determining which one of one or more addressable targets is the designated target using an internal system memory map; and
routing said request to said designated target over a target connection port coupled to said internal switching fabric, wherein said request routed to said designated target further comprises a registered, point-to-point signal having a plurality of pipeline stages;
wherein said internal switching fabric, said one or more requesters, and said one or more addressable targets are all included on a single semiconductor integrated circuit, wherein each said addressable target has a unique address space and further comprises one or more of the following: resident memory, a memory controller for resident or off-chip memory, an addressable bridge to a device, an addressable bridge to a system, or an addressable bridge to a subsystem, and wherein said internal switching fabric routes signals between said requesters and said addressable targets and further comprises one or more arbiters and one or more decoder/router elements that receive said request from a requestor;
wherein one of said one or more decoder/router elements further comprises one of the following:
a decoder/router element that routes requests to all of said one or more addressable targets using an internal system memory map that includes unique address space information for all of said one or more addressable targets;
a decoder/router element that routes requests to less than all of said one or more addressable targets using an internal system memory map that includes unique address space information for all of said one or more addressable targets; or
a decoder/router element that routes requests to less than all of said one or more addressable targets using an internal system memory map that includes unique address space information for less than all of said one or more addressable targets; and
wherein one of said one or more requestors and one of said one or more addressable targets together further comprise a single device having an independently accessible requester port and an independently accessible target port; or
one of said one or more addressable targets further comprises a single device having two independently accessible target ports.

15. A program storage device readable by a computer that tangibly embodies a program of instructions executable by the computer to perform a method to use a System-on-Chip (SOC) interconnection apparatus, said method comprising:
receiving a request from one of one or more requestors over a requestor connection port coupled to said one requestor and to an internal switching fabric;
determining which one of one or more addressable targets is the designated target using an internal system memory map; and
routing said request to said designated target over a target connection port coupled to said internal switching fabric, wherein said request routed to said designated target further comprises a registered, point-to-point signal having a plurality of pipeline stages;
wherein said internal switching fabric, said one or more requesters, and said one or more addressable targets are all included on a single semiconductor integrated circuit, wherein each said addressable target has a unique address space and further comprises one or more of the following: resident memory, a memory controller for resident or off-chip memory, an addressable bridge to a device, an addressable bridge to a system, or an addressable bridge to a subsystem, and wherein said internal switching fabric routes signals between said requestors and said addressable targets and further comprises one or more memory arbiters and one or more decoder/router elements that receive said request from a requestor;
wherein one of said one or more decoder/router elements further comprises one of the following:
a decoder/router element that routes requests to all of said one or more addressable targets using an internal system memory map that includes unique address space information for all of said one or more addressable targets;
a decoder/router element that routes requests to less than all of said one or more addressable targets using an internal system memory map that includes unique address space information for all of said one or more addressable targets; or
a decoder/router element that routes requests to less than all of said one or more addressable targets using an internal system memory map that includes unique address space information for less than all of said one or more addressable targets; and
wherein one of said one or more requesters and one of said one or more addressable targets together further comprise a single device having an independently accessible requestor port and an independently accessible target port; or
one of said one or more addressable targets further comprises a single device having two independently accessible target ports.
